(19) United States
(12) Patent Application Publication
(10) Pub. No.: US 2010/0313860 A1
(43) Pub. Date: Dec. 16, 2010

(54) APPARATUS FOR REMOVAL OF OIL FROM POSITIVE CRANKCASE VENTILATION SYSTEM

(75) Inventors: Alan S. Miller, Farmington Hills, MI (US); Timothy L. Gibbs, Bloomfield Hills, MI (US)

Correspondence Address: Cantor Colburn LLP-General Motors, 20 Church Street, 22nd Floor, Hartford, CT, 06103, US

(73) Assignee: GM GLOBAL TECHNOLOGY OPERATIONS, INC., Detroit, MI (US)

(21) Appl. No.: 12/484,400

(22) Filed: Jun. 15, 2009

(51) Int. Cl. F02B 25/06; F02F 11/00

(52) U.S. Cl. 123/573; 123/574; 277/591

(57) ABSTRACT

A gasket for an internal combustion engine comprises a sheet portion and a PCV impaction surface formed in the sheet portion. The PCV impaction surface is configured to extend across, and partially close, a crankcase ventilation system passage. A plurality of apertures extend through the PCV impaction surface and are configured to allow crankcase gas to flow freely in the crankcase ventilation system passage while the PCV impaction surface is configured to separate oil droplets from the crankcase gas by impaction of the droplets with the surface.

### FIELD OF THE INVENTION

Exemplary embodiments of the present invention are related to a positive crankcase ventilation system for an internal combustion engine.

### BACKGROUND

During engine operation, combustion gas may bypass the cylinder piston rings and enter the engine crankcase. The leaked combustion gas is referred to as blow-by gas and may comprise unburned intake air/fuel mixture, exhaust gas, oil mist and water vapor.

A positive crankcase ventilation (PCV) system is typically employed to ventilate the crankcase and to recirculate the blow-by gas to the intake side of the internal combustion engine for burning in a combustion chamber of the engine. The PCV system takes advantage of the negative pressure in the engine intake to draw the gas out of the crankcase and into a combustion air supply system associated with the intake side of the engine.

Partly as a result of packaging concerns, as well as environmental effects on PCV systems which are disposed externally of the engine cylinder block, some PCV systems have been incorporated into the engine block and cylinder head castings. Such an internal placement of the PCV system operates to minimize the risk of freezing during cold weather operation of the engine and to assist in the packaging of the engine, especially in vehicular applications.

During high performance and other operating conditions of the engine, oil from the main bearing leakage may be centrifugally thrown into the internal PCV system passages by the crankshaft. The oil spray may be mixed into the blow-by gas and drawn with this gas into the PCV system compromising its operational integrity.

The need exists for an engine integral PCV system that is protected from excess oil which may enter the system under certain operating conditions.

### SUMMARY OF THE INVENTION

In an exemplary embodiment of the present invention, a gasket for an internal combustion engine comprises a sheet portion and a PCV impaction surface formed in the sheet portion. The PCV impaction surface is configured to extend across, and partially close, a crankcase ventilation system passage. A plurality of apertures extend through the PCV impaction surface and are configured to allow crankcase gas to flow freely in the crankcase ventilation system passage while the PCV impaction surface is configured to separate oil droplets from the crankcase gas by impaction of the droplets with the surface.

In another exemplary embodiment of the present invention, an internal combustion engine comprises a plurality of assembled components, a gasket disposed between the plurality of assembled components and a crankcase ventilation system comprising a passage extending through the plurality of assembled components and the gasket. A PCV impaction surface is integral with the gasket and extends across the crankcase ventilation system passage to partially close the passage. A plurality of apertures extend through the PCV impaction surface and are configured to allow crankcase gas to flow freely in the crankcase ventilation system passage while the PCV impaction surface is configured to separate oil droplets from the crankcase gas by impaction of the droplets with the surface.

In yet another embodiment of the present invention, an internal combustion engine comprises an engine block including a crankshaft portion, a cylinder head assembled to the engine block, a cylinder head gasket interposed between the engine block and the cylinder head and a combustion air intake system fluidly connected to the cylinder head. A PCV system comprises a passage extending from the crankshaft portion, through the engine block, the cylinder head gasket and the cylinder head. A PCV impaction surface is disposed in the cylinder head gasket and extends across the PCV system passage to partially close the passage. A plurality of apertures extend through the PCV impaction surface wherein the plurality of apertures are configured to allow gas from the crankshaft portion to flow freely in the PCV system passage between the crankshaft portion of the engine block and the cylinder head while the PCV impaction surface is configured to separate oil droplets from the crankcase gas by impaction of the droplets with the PCV impaction surface.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

Other objects, features, advantages and details appear, by way of example only, in the following detailed description of embodiments, the detailed description referring to the drawings in which:

FIG. 1 is a longitudinal, sectional view of a cylinder bank of an internal combustion engine embodying aspects of the present invention;

FIG. 2 is a partial sectional view of the internal combustion engine of FIG. 1, taken along section 2-2 of FIG. 1;

FIG. 3 is a partial sectional view of the internal combustion engine of FIG. 1, taken along section 3-3 of FIG. 2;

FIG. 4 is a partial perspective view of a cylinder head gasket embodying aspects of the present invention; and

FIG. 5 is a partial sectional view of the internal combustion engine of FIG. 1, taken along section 2-2, embodying aspects of another embodiment of the present invention.

### DESCRIPTION OF THE EMBODIMENTS

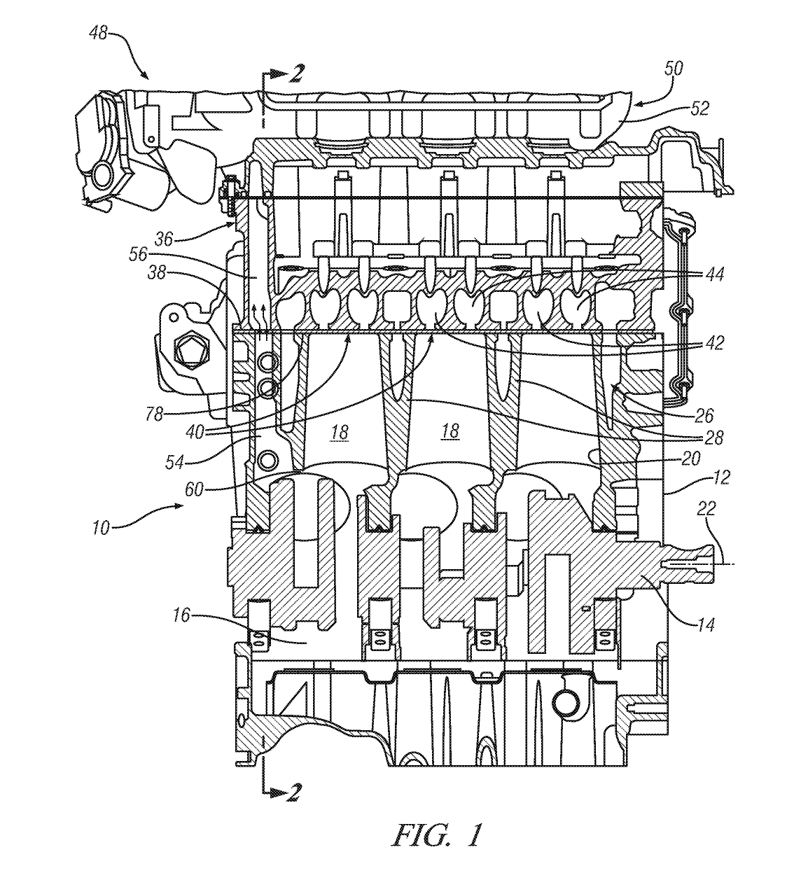

In accordance with an exemplary embodiment of the present invention, FIG. 1 illustrates a portion of an engine 10 comprising a plurality of components such as an engine block 12 having a crankshaft 14 housed in a crankshaft portion 16 (“crankcase”) of the engine block. Cylinders 18, defined by cylinder walls 20, are arranged in series along the longitudinal axis 22 of the engine block 12. The sectional view of FIG. 1 is taken obliquely to the axes of cylinders 18 (not shown), such that cylinder walls 20 appear to be tapered; however, cylinders 18 are of conventional right cylindrical configuration. Each cylinder 18 houses a piston (not shown) for reciprocation therein during operation of the engine 10. To cool the cylinders 18, an associated cooling jacket 26 is defined within the engine block 12. The cooling jacket 26 includes a cooling jacket wall 28, which may extend generally parallel to the cylinder walls 20 and may be spaced radially therefrom. The cooling jacket 26 may generally extend from a coolant inlet (not shown) at one end of the engine block 12, along both sides of the cylinders 18, to a coolant outlet (not shown) at the opposing end of the cylinder block. Coolant circulates through cooling jacket 26 to transfer heat out of the cylinder walls 20.

A cylinder head 36 is mounted to the top of the engine block 12 with a head gasket 38 interposed therebetween and operable to seal the space between the cylinder head and the engine block while also enabling fluid communication therebetween. The cylinder head 36 closes each cylinder 18 and cooperates with each piston to define combustion chambers 40. Each combustion chamber 40 has at least one intake port 42 that extends through the cylinder head 36 to deliver an air/fuel mixture to the cylinder 18. A combustion air intake system 48 fluidly connected to the cylinder head 36 includes an intake manifold 50 mounted to the cylinder head and may include an upstream throttle body (not shown) or other device which is operable to meter an air/fuel intake charge into the intake plenum 52 that distributes the charge to the intake ports 42 of the cylinder head 36.

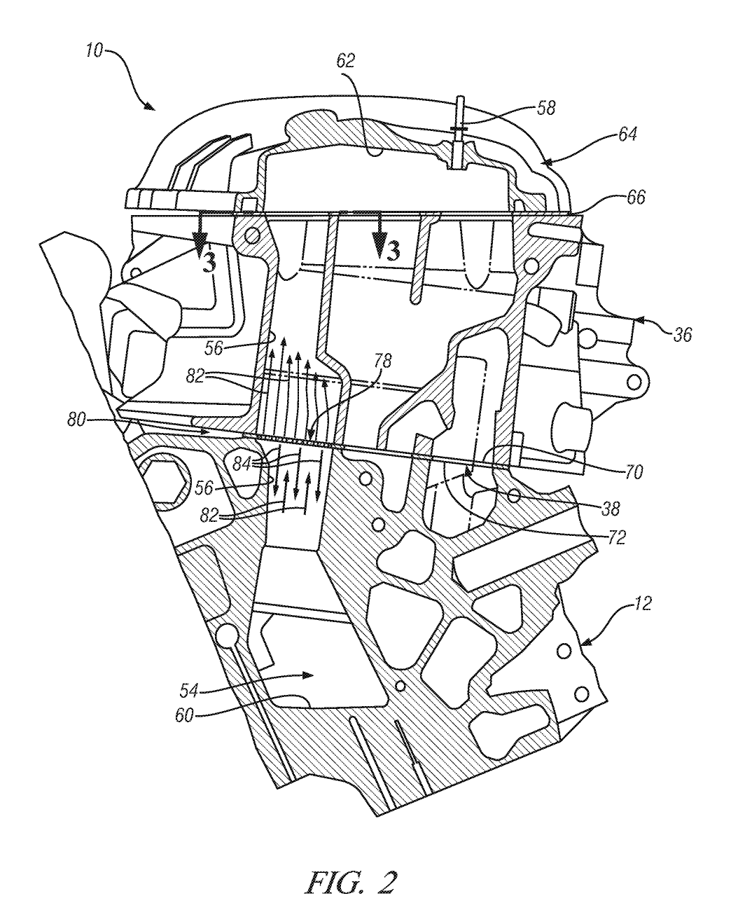

During operation of the engine 10, the intake stroke of the piston draws intake air through the intake manifold 50 and intake ports 42 to the combustion chambers 40. During the power stroke of the engine, a portion of the combustion gas in combustion chambers 40 may blow by the pistons and into the crankshaft portion 16 of the engine block 12. Referring now to FIGS. 1 and 2, the combustion or blow-by gas 82 may include corrosive exhaust gas, unburned intake air/fuel mixture, oil mist or water vapor, in any combination. In order to remove the blow-by 82 gas from the crankshaft portion 16 of the engine 10, a positive crankcase ventilation (“PCV”) system, shown generally as 54 in also shown in FIG. 1, is configured to ventilate the crankcase 16 and to recirculate the blow-by gas 82 to the intake system of the engine to be burned in the combustion chambers 40.

In an exemplary embodiment illustrated in FIGS. 1 and 2, portions of the PCV system 54 are integrally formed or cast within the engine block 12 and cylinder head 36, as well as other related components. The PCV system 54 may include an air/oil passage 56, which has respective portions cast integrally into the engine block 12 and cylinder head 36. The PCV system 54 may utilize a labyrinthine structure that is useful for separating oil droplets 84 from the blow-by gas 82 in the PCV system 54 and returning the accumulated oil droplets 84 to the crankshaft portion 16 of the engine block 12.

The PCV system 54 is in flow communication with the crankcase 16 via crankcase opening 60 at a lower end of air/oil passage 56 to allow blow-by gas 82 to exit the crankcase and enter the PCV system. An upper transfer passage 62 fluidly communicates with the upper end of the air/oil passage 56 and is configured to transfer blow-by gas 82 to the intake system outlet 58. The upper transfer passage 62 may be integrally cast into the cylinder head 36 or, as illustrated in FIG. 2, may extend through valve cover 64 which is mounted to the top of the cylinder head 36 with a valve cover gasket 66 interposed therebetween.

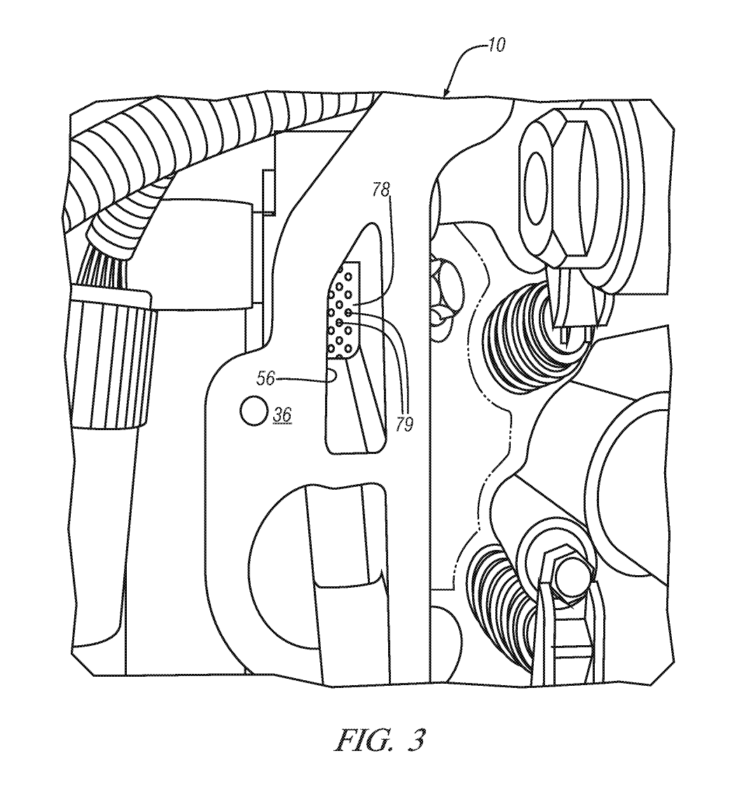

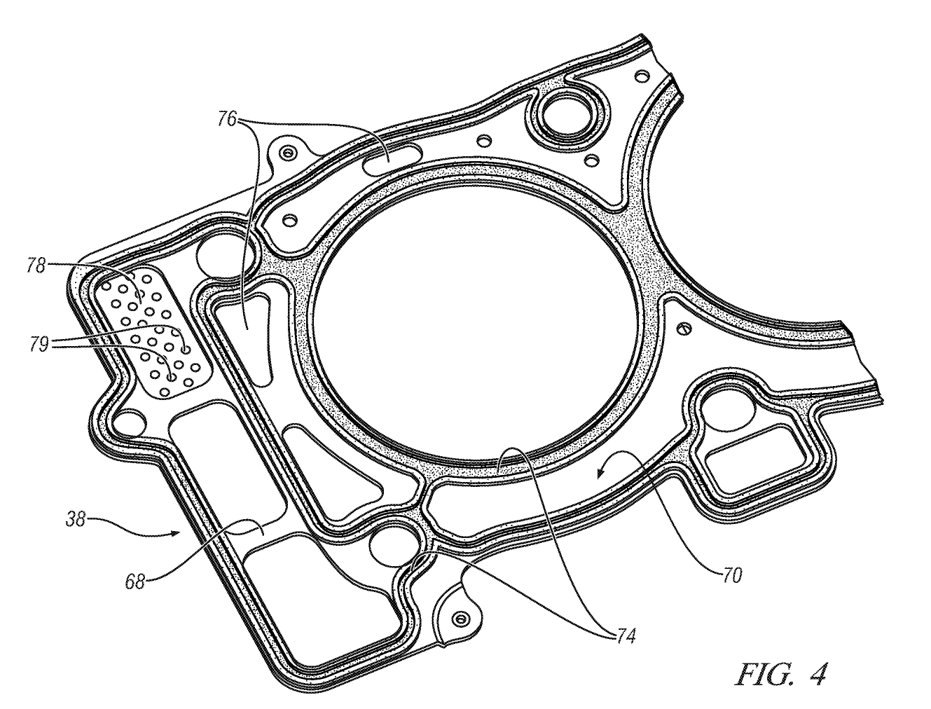

Referring again to FIGS. 2 and 3, the cylinder head gasket 38 is interposed between the cylinder head 36 and the engine block 12 at the interface of the two components. The intent of the cylinder head gasket is to maintain a sealing relationship between the cylinder head 36 and the engine block 12 that includes sealing containment of high pressure combustion gases in the combustion chambers 40, coolant in the cooling jacket 26 and crankcase or blow-by gas 82 in the PCV system 54. In an exemplary embodiment shown in FIGS. 2 and 4, the cylinder head gasket 38 is constructed of one or more layers of semi-rigid or rigid sheet such as steel sheet 68 with upper and lower contact faces 70, 72 respectively, including sealing feature 74, such as integrally formed raised sealing beads or a rubber-like sealing material that facilitates the sealing relationship between the cylinder head 36 and the engine block 16. The head gasket 38 may also be constructed of other suitable materials such as copper sheet, a composite such as asbestos or graphite or a high temperature elastomer. Coolant apertures 76 are formed in the head gasket 38 and are located to align with the coolant jacket walls 28 of the cooling jacket 26, in the cylinder head 36 and engine block 16, so as to permit unimpeded flow of coolant from one component to the other. The passages may be stamped into the steel sheet 68, cut or otherwise formed therein.

Referring to FIGS. 1-4, a PCV impaction surface or plate 78 is located in the cylinder head gasket 38 and is configured to partially close the PCV air oil passage 56 at the PCV interface 80 between the cylinder head 36 and the engine block 16. In an exemplary embodiment, the PCV impaction surface 78 is an integrally formed portion of the steel sheet 68 and includes a series of perforations or apertures 79 extending therethrough. The perforated PCV impaction surface 78 is thus configured to allow crankcase, or blow-by gas 82 to flow freely in air/oil passage 56 between the crankcase portion 16 of the engine block 12 and the cylinder head 36. During high acceleration or cornering of the vehicle, oil droplets 84 that may be thrown into the PCV air/oil passage 56 by the crankshaft 14 will impact the perforated PCV impaction surface 78 resulting in separation, accumulation and return to the crankcase 16 of the oil droplets 84 from the blow-by gas 82 thereby improving (reducing) the oil consumption characteristics of the PCV system 54. The improvement in the oil consumption is accomplished without the need for any additional hardware, PCV system volume or cost.

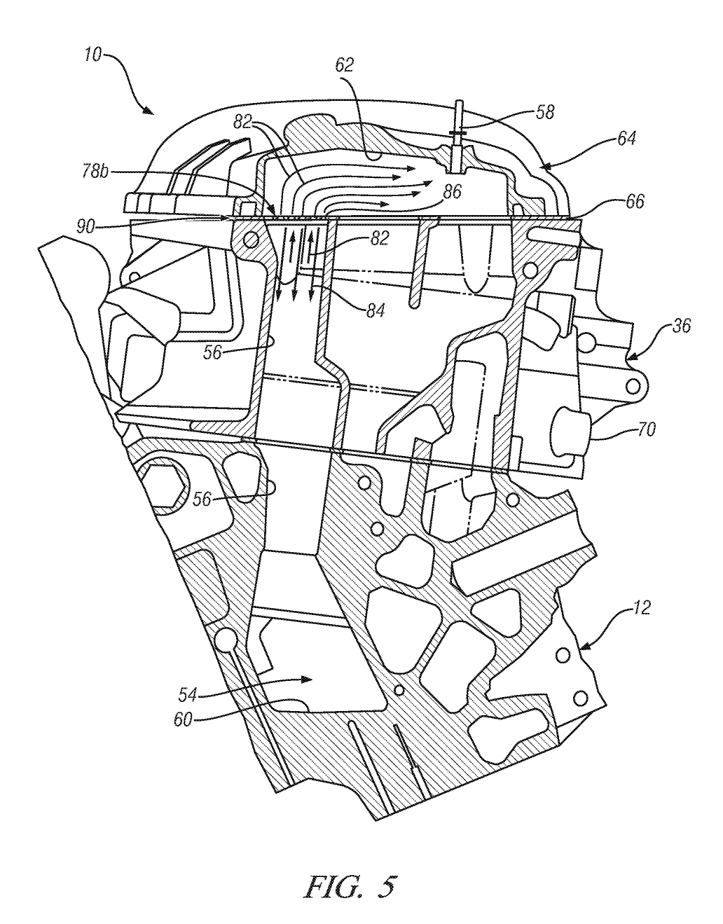

Referring to FIGS. 1-4, while the PCV impaction surface 78 has thus far been illustrated as integrally stamped or formed into the steel sheet 68 of the head gasket 38, it is of course contemplated that the impaction surface or plate could comprise a separate perforated plate or screen portion which is positioned between the cylinder head 36 and engine block 12 at the PCV interface 80 of the air/oil passage 56 without deviating from the scope of the invention. In addition, while the PCV impaction surface 78 has been illustrated as integrally stamped or formed into the steel sheet 68 of the head gasket 38, it is contemplated that the impaction surface may also comprise a similarly constructed portion of the valve cover gasket 66, as illustrated in FIG. 5. In such an embodiment, the PCV impaction surface 78b may be configured to span the PCV interface 90 of the air/oil passage 56 with the upper transfer passage 62 of the valve cover 64 with similar, oil removing effect.

While the invention has been described with reference to exemplary embodiments, it will be understood by those skilled in the art that various changes may be made and equivalents maybe substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. A gasket for an internal combustion engine comprising:
a sheet portion;
a PCV impaction surface formed in the sheet portion and configured to extend across, and partially close, a crankcase ventilation system passage; and
a plurality of apertures extending through the PCV impaction surface wherein the plurality of apertures are configured to allow crankcase gas to flow freely in the crankcase ventilation system passage, and the PCV impaction surface is configured to separate oil droplets from the crankcase gas by impaction of the droplets with the PCV impaction surface.

2. The gasket for an internal combustion engine of claim 1, wherein the gasket comprises a cylinder head gasket configured to be disposed between a cylinder head and an engine block of the internal combustion engine.

3. The gasket for an internal combustion engine of claim 1, wherein the gasket comprises a valve cover gasket configured to be disposed between a valve cover and a cylinder head of the internal combustion engine.

4. An internal combustion engine comprising:
a plurality of assembled components;
a gasket disposed between the plurality of assembled components; and
a crankcase ventilation system comprising a passage defined by the plurality of assembled components and the gasket, the gasket having a PCV impaction surface extending across the crankcase ventilation system passage, the PCV impaction surface having a plurality of apertures configured to allow a crankcase gas to flow freely in the crankcase ventilation system passage while the PCV impaction surface is configured to separate a plurality of oil droplets from the crankcase gas by impaction of the droplets with the PCV impaction surface.

5. The internal combustion engine of claim 4, wherein the plurality of assembled components comprise an engine block and a cylinder head.

6. The internal combustion engine of claim 5, wherein the crankcase ventilation system passage is formed integrally in the engine block and the cylinder head.

7. The internal combustion engine of claim 4, wherein the plurality of assembled components comprise a cylinder head and a valve cover.

8. The internal combustion engine of claim 7, wherein the crankcase ventilation system passage is formed integrally in the cylinder head and the valve cover.

9. An internal combustion engine comprising:
an engine block including a crankshaft portion;
a cylinder head assembled to the engine block;
a cylinder head gasket interposed between the engine block and the cylinder head;
a combustion air intake system fluidly connected to the cylinder head;
a positive crankcase ventilation system comprising a passage extending from the crankshaft portion and defined by the engine block, the cylinder head gasket and the cylinder head;
a PCV impaction surface disposed in the cylinder head gasket and extending across the positive crankcase ventilation system passage to partially close the passage; and
a plurality of apertures extending through the PCV impaction surface wherein the plurality of apertures are configured to allow gas from the crankshaft portion to flow freely in the positive crankcase ventilation system passage between the crankshaft portion of the engine block and the cylinder head and wherein the PCV impaction surface is configured to separate a plurality of oil droplets from the crankcase gas by impaction of the droplets with the PCV impaction surface.

10. The internal combustion engine of claim 9, wherein the PCV impaction surface is integrally formed with the cylinder head gasket.

11. The internal combustion engine of claim 9, wherein the PCV impaction surface is a separate screen member attached to the cylinder head gasket.
